(19) United States
(12) Patent Application Publication
(10) Pub. No.: US 2015/0340746 A1
(43) Pub. Date: Nov. 26, 2015

(54) BATTERY MODULE PROVIDED WITH A PELTIER CELL

(71) Applicant: RENAULT s.a.s., Boulogne-Billacourt (FR)

(72) Inventors: Masato ORIGUCHI, Rambouillet (FR); Gwenaelle PASCALY, Versailles (FR); Caroline MARCHAL, Montigny-Le-Bretonneux (FR)

(73) Assignee: RENAULT s.a.s., Boulogne-Billancourt (FR)

(21) Appl. No.: 14/374,722

(22) PCT Filed: Jan. 24, 2013
(86) PCT No.: PCT/EP2013/051376

§ 371 Date: Mar. 13, 2015

(30) Foreign Application Priority Data
Feb. 3, 2012 (FR) 1200328

(51) Int. Cl. H01M 10/6572; H01M 10/625; H01M 10/637; H01M 10/613

(52) U.S. Cl. CPC H01M 10/6572; H01M 10/613; H01M 10/625; H01M 10/637; H01M 2220/20

(57) ABSTRACT

A battery module including: a storage case, at least one storage battery cell housed inside the storage case, at least one Peltier cell with a first face in direct or indirect contact, via a heat conduction member, with the storage battery cell and a second face in direct or indirect contact, via a heat conduction member, with an outside of the storage case, and a unit controlling the Peltier cell. The Peltier cell and the control unit are supplied with current by the storage battery cell.

### TECHNICAL FIELD TO WHICH THE INVENTION RELATES

The present invention relates in a general way to batteries.

More particularly, it relates to a battery module including:
a storage casing,
at least one battery cell housed within said storage casing,
at least one Peltier cell, a first face of which is in contact, directly or indirectly via a heat conducting element, with said battery cell, and a second face of which is in contact, directly or indirectly via a heat conducting element, with the outside of the storage casing, and
a control unit for controlling said Peltier cell.

It also relates to a battery pack including at least two battery modules as mentioned above, housed in a protective case.

The invention can be applied in a particularly advantageous way to the production of battery packs for electrically propelled motor vehicles.

### PRIOR ART

Electrically propelled motor vehicles are generally provided with an electric motor supplied with current by a battery pack. Conventionally, a battery pack of this type houses a plurality of battery modules, each including a plurality of small battery cells.

The number of battery cells is calculated so that the electric motor can develop sufficient torque and power to propel the vehicle for a predetermined period.

When the battery pack supplies the electric motor, a large part of the energy developed by the battery cells is released in the form of heat. It is then necessary to cool these battery cells in such a way that their temperature never exceeds a threshold (which is about 60 degrees Celsius) above which they would be in danger of premature ageing or even irreversible damage.

For this purpose, a battery module arranged to house and cool a plurality of battery cells in a restricted and confined space is known from the document WO 2010/083983.

In this document, the battery cells are stacked on top of one another, in a particularly compact way, and are housed in a sealed storage casing.

A Peltier cell (a kind of electrically operated heat pump) is also housed in this storage casing, so that, when it is supplied with current, it enables the heat emitted by the battery cells to be discharged toward the outside by conduction.

The control unit of the Peltier cell is also housed in the storage casing.

The supply of current to the Peltier cell of each battery module then requires a special connector on the battery pack, so that the Peltier cells can be supplied with current by the accessory battery of the motor vehicle (generally a lead-acid battery).

However, this connector is costly to manufacture and requires the wiring harness of the motor vehicle to be designed accordingly. It also complicates the operation of changing the battery pack of a motor vehicle.

### OBJECT OF THE INVENTION

In order to overcome the aforesaid drawbacks of the prior art, the present invention proposes a battery module as defined in the introduction, in which said Peltier cell and said control unit are supplied with current by said battery cell.

Thus, owing to the invention, the battery modules are independent in terms of energy, and no special connection systems have to be provided on the battery pack to supply current to the Peltier cells.

The operation of changing a battery pack on a motor vehicle is thus facilitated, because the number of power connections to be disconnected and then reconnected is smaller.

Moreover, as described below, the battery module according to the invention can be associated with other battery modules and can provide a dissipative load balancing function without energy loss, the dissipated energy being used to cool or heat the other battery modules.

Other advantageous and non-limiting characteristics of the battery module according to the invention are as follows:
said control unit is housed inside the storage casing;
said Peltier cell is integrated into the storage casing so that its second face emerges on the outside of the storage casing;
the storage casing has an insulating wall which borders the Peltier cell;
at least two battery cells being housed within said storage casing, a heat conduction element is provided and is interposed between said two battery cells on the one hand, and the first face of the Peltier cell on the other hand.

The invention also proposes a battery pack as defined in the introduction, including a protective case and at least two battery modules as mentioned above, which are housed within said protective case in such a way that their Peltier cells are in contact, directly or indirectly via a heat conducting element, with the protective case.

Other advantageous and non-limiting characteristics of this battery pack are as follows:
said protective case includes a tray, a cover which hermetically seals the tray, and a power connection connected to said battery modules;
the tray is made in one piece from heat conducting material;
the tray has fins promoting heat exchange;
at least one fluid circulation channel passes through the tray;
the tray incorporates at least two inserts having a thermal conductivity which is strictly greater than that of the rest of the tray, these inserts being located, respectively, in contact with the second face of the Peltier cell of each battery module; and
the control units of the battery modules include means for detecting a difference in charge between the two battery modules, and control means adapted to cause current to be supplied to the Peltier cell of the least charged battery module, using the battery cells of the most charged battery module.

### DETAILED DESCRIPTION OF AN EXEMPLARY EMBODIMENT

The following description, which refers to the attached drawings which are provided by way of non-limiting example, will make the nature and application of the invention clear.

In the attached drawings:

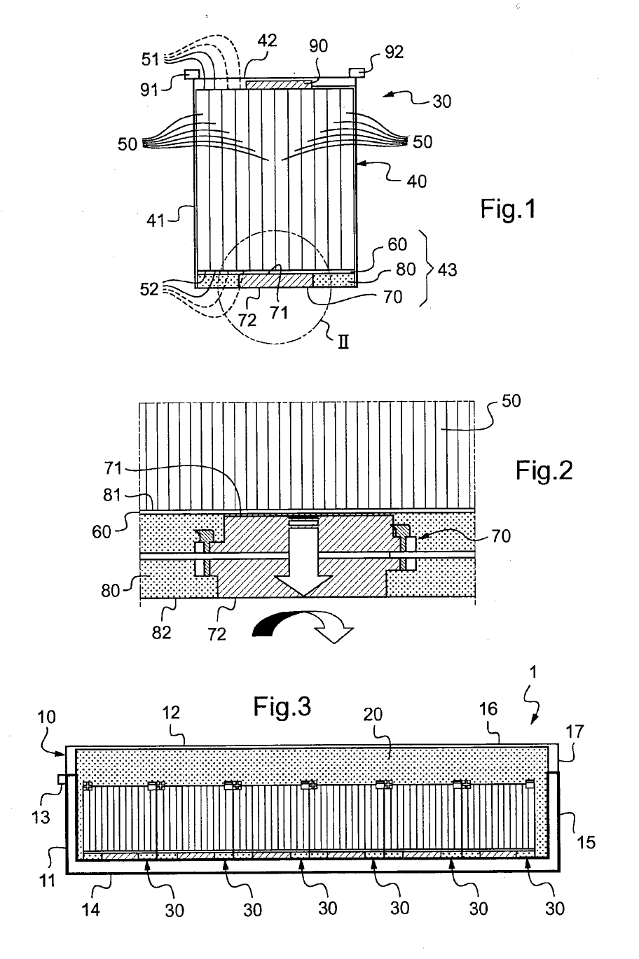

FIG. 1 is a schematic sectional view of a battery module according to the invention;

FIG. 2 is a detail view of area II of FIG. 1; and

FIGS. 3 to 6 are schematic sectional views of four embodiments of a battery pack incorporating battery modules of the type shown in FIG. 1.

In the first place, it should be noted that identical or similar elements of the different embodiments of the invention shown in the different figures are, as far as possible, identified by the same reference symbols and will not be described on every occasion.

In the description, it is also considered that a heat conducting element has a thermal conductivity of more than 1 W−m⁻¹−K⁻¹ and that a thermally insulating element has a thermal conductivity of less than 0.05 W−m⁻¹·K⁻¹.

FIG. 1 shows a battery module 30.

As shown for example in FIG. 3, this type of battery module 30 is intended to be stored with other battery modules 30 of the same type in a protective case 10, so as to form a battery pack 1 adapted to supply current to an electric motor of an electrically propelled motor vehicle.

As shown in FIG. 1, each battery module 30 includes a plurality of small battery cells 50 housed within a storage casing 40, together with a Peltier cell 70 and a control unit 90 of this Peltier cell 70.

As shown in FIG. 2, the Peltier cell 70 is a thermoelectric element having two faces, one face 71 being called cold and the other face 72 being called hot, which operates on the principle of a heat pump. Thus this Peltier cell 70 is adapted to cool the elements in contact with its cold face 71 when it is supplied with electric current (provided that its hot face 72 is not in contact with an excessively hot element).

In order to cool the battery cells 50, the cold face 71 of the Peltier cell 70 is then placed in contact, (directly or indirectly via a single heat conducting element) with the battery cells 50, while its hot face 72 is in contact (directly or indirectly via a heat conducting element) with the outside of the storage casing 40.

According to a particularly advantageous characteristic of the invention, the Peltier cell 70 and the control unit 90 are supplied with current by the battery cells 50 of the battery module 30 in question.

As will be disclosed in detail in the rest of this description, the Peltier cell 70 and the control unit can also be supplied with current by the battery cells 50 of the other battery modules 30 housed in the protective case 10 of the battery pack 1.

In the embodiment of the battery casing 30 shown in FIG. 1, the storage casing 40 has a parallelepipedal shape.

Thus it has a rectangular front wall 42, bordered at the rear by a side wall 41. This side wall 41 and this front wall 42 are made in one piece by molding from plastic material.

The storage casing 40 also has a base wall 43, formed by a plurality of elements 60, 70, 80.

As shown in FIG. 1, the battery cells 50, for their part, take the form of thin flat rectangular plates.

They are stacked against each other, so as to form a stack adjusted to the internal volume of the storage casing 40.

Each of them has two flat parallel main faces placed so as to bear against the main faces of the adjacent two battery cells 50, two side edges placed so as to bear against the side wall 41 of the storage casing 40, a front edge 51, placed facing the front wall 42 of the storage casing 40, and an opposed rear edge 52.

Each battery cell 50 is provided with two connecting terminals placed so as to project from its front edge 51.

All of the battery cells 50 are then connected in series to one another and to two phase and neutral terminals 91, 92 which project outside the storage casing 40.

As shown in FIG. 1, the Peltier cell 70 is small in size relative to the size of the stack of battery cells 50. In particular, the size of its cold face 71 is very much smaller than that of the rear face of the stack of battery cells 50.

In order to enable the Peltier cell 70 to cool all of the battery cells 50, a heat conducting element 60 is interposed here between the rear edges 52 of the battery cells 50 on the one hand, and the cold face 71 of the Peltier cell 70 on the other hand.

This heat conducting element 60 is formed here by a simple rectangular flat plate having dimensions equal to those of the front wall 42 of the storage casing 40, so that it is applied against the whole surface of the rear edges 52 of the battery cells 50.

Its dimensions are also such that it can seal the rear of the storage casing 40.

The storage casing 40 also includes a rigid insulating wall 80 which borders the Peltier cell 70 and has its front face 81 bearing on the rear face of the heat conducting element 60 (see FIG. 2). This insulating wall 80 has a thickness such that its rear face 82 is flush with the hot face 72 of the Peltier cell 70.

The insulating wall 80, the heat conducting element 60 and the Peltier cell 70 combine to form the base wall 43 of the storage casing 40.

As shown in FIG. 1, the control unit 90 includes an electronic circuit board housed in the storage casing 40, between the front edges 51 of the battery cells 50 and the front wall 42 of the storage casing 40.

It is supplied with current by two wires connected, respectively, to the two phase and neutral terminals 91, 92.

It includes a control circuit adapted to cause current to be supplied to the Peltier cell 70 from the battery module 30. For this purpose, it is connected to the two terminals of the Peltier cell 70 by two current supply wires.

This control unit 90 includes heat sensors for sensing the temperature of the cold face 71 and hot face 72 of the Peltier cell 70.

It also includes means for acquiring the percentage of charge in the battery cells 50 of the battery module 30.

In this case, these acquisition means include means for measuring the strength i₁ of the current drawn at the phase and neutral terminals 91, 92 of the battery modules, means for estimating the strength i₂ of the current sent to the Peltier cell 70, and means for calculating the percentage of charge of the battery module 30 with allowance for variations in time of these two current strengths M, i₂.

Finally, the control unit 90 includes communication means for communicating with the control units 90 of the other battery modules 30 of the battery pack 1.

Because of all these means, the control unit 90 is adapted to cause current to be supplied to the Peltier cell 70 of the least charged battery module 30, using the battery cells 50 of the most charged battery module 30.

More precisely, the control units 90 are adapted to:
determine the percentage of charge of their battery module 30,
compare this percentage of charge with the percentage of charge of the other battery modules 30, and
cause current to be supplied to the Peltier cell 70 of their battery module 30, using the battery cells 50 of the battery module 30 whose percentage of charge is greatest.

Thus the current supply to the Peltier cells 70 is used to maintain a constant balance between the different battery modules 30, thereby improving the service life of these modules. The function of balancing the charges of the battery modules 30 is thus dissipative but without energy loss.

FIGS. 3 to 6 show four embodiments of the protective case 10; 100; 110; 120 of the battery pack 1.

In these four embodiments, the protective case 10; 100; 110; 120 includes a tray 11; 101; 111; 121 which is open at the front, a cover 12; 102; 112; 122 which hermetically seals the tray 11; 101; 111; 121, and a power connection 13; 103; 113; 123 which projects outside the tray 11; 101; 111; 121.

The tray 11; 101; 111; 121 has a base wall 14; 104; 114; 124 which is bordered in front by a side wall 15; 105; 115; 125 and which delimits with the latter a housing to receive the battery modules 30.

The cover 12; 102; 112; 122 has a front wall 16; 106; 116; 126 bordered at the rear by a raised edge 17; 107; 117; 127 which is arranged to bear against the front portion of the side wall 15; 105; 115; 125 of the tray 11; 101; 111; 121.

Locking means (not shown) can be used to lock the cover 12; 102; 112; 122 onto the tray 11; 101; 111; 121 so as to keep the protective case 10; 100; 110; 120 hermetically sealed.

The power connection 13; 103; 113; 123 projects outside the tray so as to be accessible to a user wishing to connect the battery pack 1 to the electrical power circuit of the motor vehicle.

This power connection 13; 103; 113; 123 is connected in series with the battery modules 30 housed in the protective case 10; 100; 110; 120, via the phase and neutral terminals 91, 92 of these battery modules 30.

These battery modules 30 are housed here within the protective case 10; 100; 110; 120 in such a way that the hot faces 72 of their Peltier cells 70 are in contact, directly or indirectly via a single heat conducting element, with the protective case 10; 100; 110; 120.

These battery modules 30 are placed next to one another here, in an adjacent manner and in such a way that the base walls 43 of their storage casings 40 bear against the base wall 14; 104; 114; 124 of the tray 11; 101; 111; 121 of the protective case 10; 100; 110; 120.

In the embodiment shown in FIG. 3, the tray 11 is made in one piece from a heat conducting material, in such a way that its base wall 14 can discharge toward the outside the heat emitted from the hot faces 72 of the Peltier cells 70.

In the embodiment shown in FIG. 4, the tray 101 differs from the tray 11 of FIG. 3 in that at least one channel 108 for the circulation of coolant fluid passes through it.

In this embodiment, the channel 108 opens out of the tray 101 through an inlet 109A and an outlet 109B for coolant fluid, located in the side wall 105 of the tray 101. This inlet 109A and outlet 109B are then connected to a closed cooling circuit for the coolant fluid, including a simple coil for example.

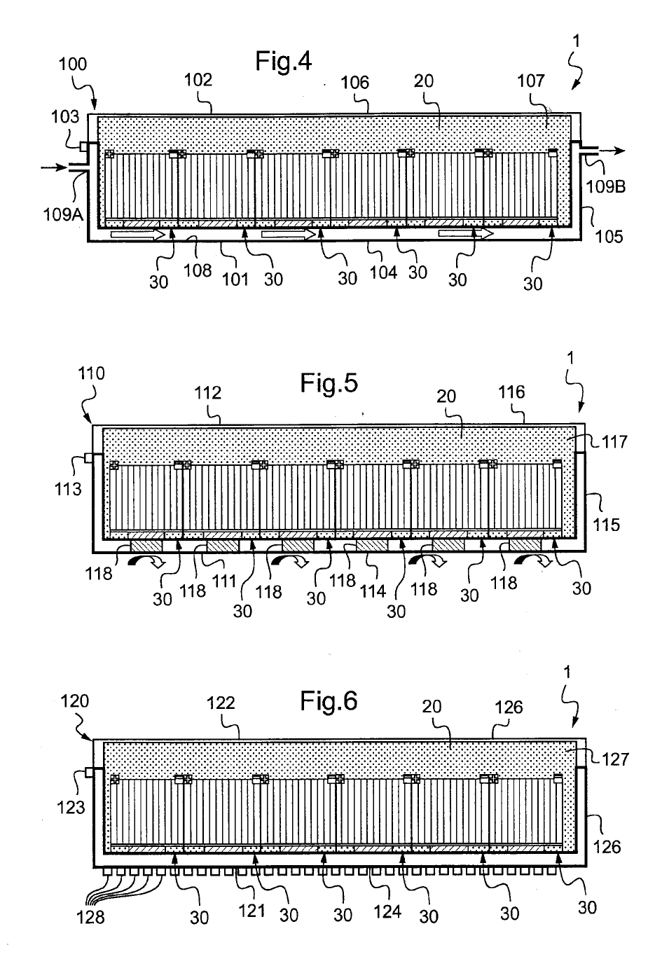

In the embodiment shown in FIG. 5, the tray 111 differs from the tray 11 of FIG. 3 in that it is made from a thermally insulating material and in that its base wall 114 incorporates heat conducting inserts 118.

In this embodiment, the heights of the inserts 118 are equal to the thickness of the base wall 114 of the tray 111, so that they extend through the latter from one side to the other.

The number of inserts 118 provided is here equal to the number of battery modules 30.

These inserts 118 have lengths and widths substantially equal to the lengths and widths of the hot faces 72 of the Peltier cells 70 of the battery modules 30. They are also located in such a way that their inner faces bear entirely against the hot faces 72 of the Peltier cells 70 of the battery modules 30.

Finally, in the embodiment shown in FIG. 6, the tray 121 differs from the tray 11 of FIG. 3 in that the outer side of its base wall 124 carries fins 128 to promote heat exchange with the outside.

The storage pack 1 also includes means (not shown) for fastening to the chassis of the motor vehicle.

Because of the hermetic nature of the protective case 10; 100; 110; 120, the storage pack 1 can be fastened in the air-conditioned passenger compartment of the motor vehicle without any risk of leakage, even in case of accident. When fastened in this way, the base wall 14; 104; 114; 124 of the protective case 10; 100; 110; 120 is kept at a temperature of about 20° C. because of the air conditioning of the passenger compartment, which enables the Peltier cells 70 of the battery modules 30 to cool the battery cells 50 correctly, regardless of the temperature outside the passenger compartment.

In a variant, it is also possible to fasten the storage pack 1 in such a way that the base wall 14; 104; 114; 124 of its protective case 10; 100; 110; 120 is flush with the underside of the vehicle body, so as to promote heat exchange with the outside when the motor vehicle is traveling.

1-12. (canceled)

13. A battery module comprising:
a storage casing;
at least one battery cell housed within the storage casing;
at least one Peltier cell, a first face of which is in contact, directly or indirectly via a heat conducting element, with the battery cell, and a second face of which is in contact, directly or indirectly via a heat conducting element, with an outside of the storage casing; and
a control unit for controlling the Peltier cell;
wherein the Peltier cell and the control unit are supplied with current by the battery cell.

14. The battery module as claimed in claim 13, wherein the control unit is housed within the storage casing.

15. The battery module as claimed in claim 13, wherein the Peltier cell is integrated into the storage casing so that its second face emerges on the outside of the storage casing.

16. The battery module as claimed in claim 15, wherein the storage casing includes an insulating wall that borders the Peltier cell.

17. The battery module as claimed in claim 13, wherein, at least two battery cells are housed within the storage casing, and a heat conduction element is provided and is interposed between the two battery cells and the first face of the Peltier cell.

18. A battery pack, comprising:
a protective case, and
at least two battery modules as claimed in claim 13, which are housed within the protective case such that their Peltier cells are in contact, directly or indirectly via a heat conducting element, with the protective case.

19. The battery pack as claimed in claim 18, wherein the protective case includes a tray, a cover that hermetically seals the tray, and a power connection connected to the battery modules.

20. The battery pack as claimed in claim 19, wherein the tray is made in one piece from heat conducting material.

21. The battery pack as claimed in claim 20, wherein the tray includes fins that promote heat exchange.

22. The battery pack as claimed in claim 19, wherein at least one fluid circulation channel passes through the tray.

23. The battery pack as claimed in claim 19, wherein the tray incorporates at least two inserts having a thermal conductivity which is strictly greater than that of the rest of the tray, the inserts being located, respectively, in contact with the second face of the Peltier cell of each battery module.

24. The battery pack as claimed in claim 18, wherein the control units of the battery modules include means for detecting a difference in charge between the two battery modules, and control means to cause current to be supplied to the Peltier cell of a least charged battery module, using the battery cells of a most charged battery module.
